(19) United States
(12) Patent Application Publication
(10) Pub. No.: US 2025/0238911 A1
(43) Pub. Date: Jul. 24, 2025

(54) IMAGE PROCESSING APPARATUS, IMAGING SYSTEM, IMAGE PROCESSING METHOD, AND STORAGE MEDIUM

(71) Applicant: CANON KABUSHIKI KAISHA, Tokyo (JP)

(72) Inventor: YOSUKE TAKADA, Kanagawa (JP)

(21) Appl. No.: 18/986,438

(22) Filed: Dec. 18, 2024

(30) Foreign Application Priority Data
Dec. 21, 2023 (JP) 2023-215572

(51) Int. Cl. G06T 7/00; G06T 3/4053; G06T 5/70; G06V 10/56; G06V 10/60; H04N 23/61; H04N 23/695; H04N 23/88

(52) U.S. Cl. CPC G06T 7/0002; G06T 3/4053; G06T 5/70; G06V 10/56; G06V 10/60; H04N 23/61; H04N 23/695; H04N 23/88; G06T 2207/20182; G06T 2207/30168

(57) ABSTRACT

An image processing apparatus includes an image processing apparatus that subjects a captured image, acquired by an imaging unit, to image quality enhancement processing to reduce an image quality defect and an adjustment unit that adjusts, based on a result of analyzing the captured image having been subjected to the image quality enhancement processing, at least one of parameters related to the imaging unit or parameters related to the image quality enhancement processing.

### BACKGROUND

### Field

The present disclosure relates to an image processing technique for reducing an image quality defect of an image.

### Description of the Related Art

Common monitoring cameras are subjected to dynamic range adjustment and brightness adjustment. If low illuminance or fog occurs, images captured by a camera are subjected to image quality enhancement processing such as noise reduction and fog and mist removal as required. In recent years, Deep Learning (DL) technology is used in image quality enhancement processing for exceeding the conventional performance.

Under a bad environment such as starlight with very low illuminance and dense fog preventing visible recognition of a distant object, the target portion cannot necessarily be visually recognized favorably even by subjecting an image to the image quality enhancement processing based on deep learning. In such a case, it is typical to manually change the parameters for the lens aperture and shutter speed of the camera, and to adjust image processing parameters to improve the visibility. However, in manual adjustment, it is difficult to determine which parameters are to be changed to more effectively to improve the visibility. The enhancement of the image quality is visually checked while adjusting a plurality of parameters, which results in increase work on the user's part.

Japanese Patent Application Laid-Open No. 2014-146979 discusses a technique for detecting a moving object in a monitoring region, and transmitting, to a monitoring camera, control information for changing the luminance of the region including the object to a predetermined value to favorably display the moving object. In this technique, the moving object is defocused or an image quality defect such as noise and artifact is emphasized. In such a case, camera and image processing parameters need to be manually adjusted, and visually checking the result of parameter adjustment each time can be troublesome. Also, such an adjustment needs to be performed after each operation instead of being performed only once after the camera installation.

### SUMMARY

The present disclosure is directed to improving image visibility with a reduced impact on a user.

According to an aspect of the present disclosure, an image processing apparatus includes an image processing unit configured to subject a captured image, acquired by an imaging unit, to image quality enhancement processing to reduce an image quality defect and an adjustment unit configured to adjust, based on a result of analyzing the captured image having been subjected to the image quality enhancement processing, at least one of parameters related to the imaging unit or parameters related to the image quality enhancement processing.

Further features of the present disclosure will become apparent from the following description of exemplary embodiments with reference to the attached drawings.

### BRIEF DESCRIPTION OF THE DRAWINGS

FIGS. 1A, 1B, and 1C illustrate examples configurations of imaging systems.

FIG. 2 illustrates an example of a hardware configuration of an imaging system according to a first exemplary embodiment.

FIG. 3 illustrates an example of a functional configuration of the imaging system according to the first exemplary embodiment.

FIG. 4 illustrates examples of analysis processing and a correction parameter calculation method.

FIG. 5 is a flowchart illustrating an example of processing in the imaging system according to the first exemplary embodiment.

FIGS. 6A to 6F are flowcharts illustrating examples of analysis processing and correction parameter calculation processing according to the first exemplary embodiment.

FIG. 7 illustrates an example of a functional configuration of an imaging system according to a second exemplary embodiment.

FIGS. 8A and 8B illustrate examples of User Interfaces (UIs) of the imaging system according to the second exemplary embodiment.

FIG. 9 is a flowchart illustrating an example of processing in the imaging system according to the second exemplary embodiment.

FIG. 10 illustrates an example of a hardware configuration of an imaging system according to a third exemplary embodiment.

FIG. 11 illustrates an example of a functional configuration of the imaging system according to the third exemplary embodiment.

FIG. 12 is a flowchart illustrating an example of processing in the imaging system according to the third exemplary embodiment.

### DESCRIPTION OF THE EMBODIMENTS

Exemplary embodiments of the present disclosure will be described below with reference to the accompanying drawings. The following exemplary embodiments do not limit the present disclosure. Not all of the combinations of the features described in the exemplary embodiments are indispensable to the solutions for the present disclosure. The configurations of the following exemplary embodiments can be suitably corrected or modified depending on the specifications and various conditions (operating conditions and operating environment) of an applied apparatus. Parts of the following exemplary embodiments can be suitably combined. In the following exemplary embodiments, identical components are assigned the same reference numerals.

A first exemplary embodiment will be described below directed to a method for performing image quality enhancement processing according to imaging conditions and captured image scenes, analyzing the result of the processing, calculating correction parameters if an image quality defect is detected or the visibility can be further improved, and updating the camera and edge device parameters.

### <System Configuration>

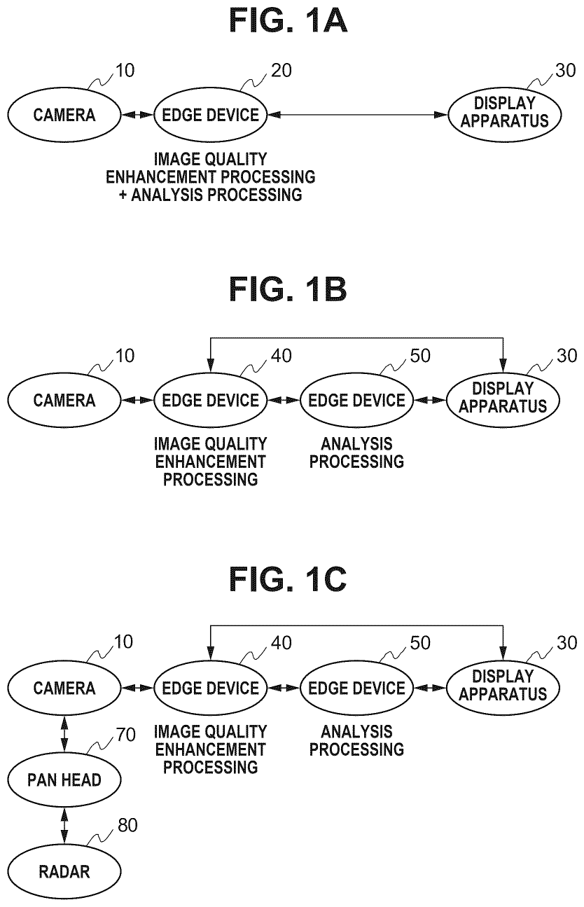

FIG. 1A illustrates an example configuration of an imaging system according to the first exemplary embodiment. The imaging system illustrated in FIG. 1A includes a camera 10 for image capturing, an edge device 20 for subjecting a captured image to image quality enhancement processing and analysis processing, and a display apparatus 30 for displaying a screen of an image having been subjected to the image quality enhancement processing.

### <Hardware Configuration of System>

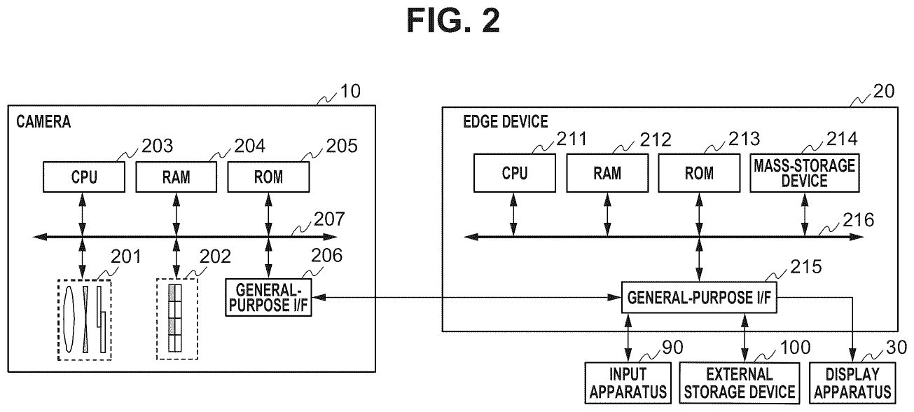

FIG. 2 is a block diagram illustrating an example of a hardware configuration of the imaging system according to the first exemplary embodiment.

The camera 10 according to the present exemplary embodiment is used to capture an image of a target region, and a captured image (RAW image) acquired by the camera 10 is transmitted to the edge device 20. The camera 10 is, for example, a monitoring camera for capturing a monitoring target region. The camera 10 includes an optical unit 201, an image sensor 202, a central processing unit (CPU) 203, a random access memory (RAM) 204, a read only memory (ROM) 205, and a general-purpose interface (I/F) 206 that are connected with each other via a system bus 207. The camera 10 is connected with the edge device 20 via a general-purpose I/F 206.

The optical unit 201 is a lens barrel including a zoom lens, focusing lens, camera shake correction lens, aperture, and shutter, and condenses light information of a subject. The image sensor 202, specifically, a complementary metal oxide semiconductor (CMOS) sensor or a single photon avalanche diode (SPAD) sensor, includes an image sensor and a color filter having a predetermined array such as a Bayer array. The CMOS sensor receives, by using the image sensor, a light flux condensed by the optical unit 201 via the color filter, and converts the light flux into an analog electrical signal including color information of a subject. A CMOS sensor measures the quantity of light accumulated in pixels during a fixed period of time while a SPAD sensor counts the number of light particles (photons) entering the pixels one by one. An analog-to-digital (A/D) converter (not illustrated) converts the analog electrical signal into a digital signal to generate RAW image data.

The CPU 203 uses the RAM 204 as a work memory and executes a program stored in the ROM 205 to control each component of the camera 10 via the system bus 207. The general-purpose I/F 206 is, for example, a serial bus interface such as a universal system bus (USB), IEEE1394, high-definition multimedia interface (HDMI(registered trademark)), or serial digital interface (SDI).

The edge device 20 according to the present exemplary embodiment acquires the RAW image data (Bayer array) output from the camera 10, as an input image to be subjected to the image quality enhancement processing. The edge device 20 subjects the input image to be subjected to the image quality enhancement processing to the image quality enhancement processing, and transmits an output image (image having been subjected to the image quality enhancement processing) to the display apparatus 30. Then, the edge device 20 subjects the output image to the analysis processing, calculates correction parameters for the camera 10 or the edge device 20 as required based on the analysis result, transmits the correction parameters, and updates the image quality enhancement processing. Accordingly, the output image output from the edge device 20 is also updated. The present exemplary embodiment handles two different types of correction parameters: camera parameters transmitted to the camera 10 and image processing parameters transmitted to the edge device 20. The camera parameters are mainly used to set imaging conditions of the camera 10 while image processing parameters relate to the image quality enhancement processing.

The edge device 20 includes a CPU 211, a RAM 212, a ROM 213, a mass-storage device 214, and a general-purpose I/F 215 that are connected with each other via a system bus 216. The edge device 20 is also connected with the camera 10, the display apparatus 30, an input apparatus 90, and an external storage device 100 via the general-purpose I/F 215.

The CPU 211 uses the RAM 212 as a work memory and executes a program stored in the ROM 213 to totally control each component of the edge device 20 via the system bus 216. The mass-storage device 214 is, for example, a hard disk drive (HDD) or a solid state drive (SSD) and stores various types of data to be handled by the edge device 20. The CPU 211 writes data to the mass-storage device 214 and reads data stored in the mass-storage device 214 via the system bus 216. The general-purpose I/F 215 is, for example, a serial bus interface such as a USB, IEEE 1394, HDMI, and SDI. The edge device 20 acquires data from the external storage device 100 (a memory card, compact flash (CF) card, Secure Digital (SD) card, USB memory, and other various types of storage media) via the general-purpose I/F 215. The edge device 20 also receives a user instruction from the input apparatus 90, such as a mouse and keyboard, via the general-purpose I/F 215. The edge device 20 also outputs the image data processed by the CPU 211 to the display apparatus 30 (e.g., various image display devices such as a liquid crystal display) via the general-purpose I/F 215. The edge device 20 also acquires the data of the captured image (RAW image) from the camera 10 via the general-purpose I/F 215.

### <Functional Configuration of System>

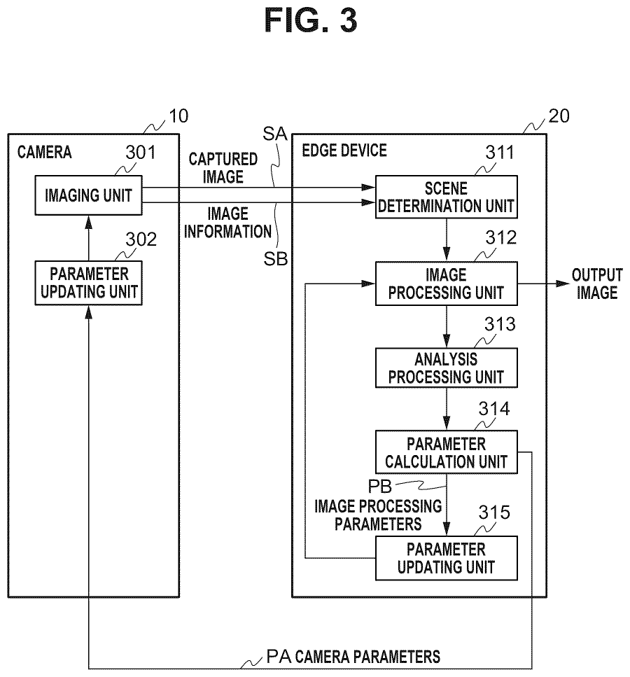

FIG. 3 is a block diagram illustrating an example of a functional configuration of the imaging system according to the first exemplary embodiment. As illustrated in FIG. 3, the camera 10 includes an imaging unit 301 and a parameter updating unit 302. The edge device 20 includes a scene determination unit 311, an image processing unit 312, an analysis processing unit 313, a parameter calculation unit 314, and a parameter updating unit 315. The camera 10 is an example of an imaging unit, and the edge device 20 is an example of an image processing apparatus. Each function unit illustrated in FIG. 3 is implemented by the CPU 203 or the CPU 211 executing a computer program for implementing each function. All or a part of the function units illustrated in FIG. 3 can be implemented by hardware.

The configuration illustrated in FIG. 3 can be suitably modified or changed. For example, one function unit can be divided into a plurality of function units, and two or more function units can be integrated into one function unit. The configuration illustrated in FIG. 3 can be implemented by two or more apparatuses. In this case, these apparatuses are connected via a circuit or wired or wireless network, and perform data communication with each other to cooperatively operate to implement each piece of processing according to the present exemplary embodiment.

Each function unit of the camera 10 will be described below.

The imaging unit 301 captures a target region and transmits a captured image SA and imaging information SB to the edge device 20. Examples of the imaging information include an aperture value, shutter speed, gain (sensitivity), focal distance, white balance calculation mode, and other imaging-time setting values. The parameter updating unit 302 receives camera parameters PA from the edge device 20 and updates the setting values of the camera 10 based on the received camera parameters PA. The camera parameters include the aperture value, shutter speed, gain (sensitivity), focal distance, white balance calculation mode, and other camera setting values.

Each function unit of the edge device 20 will be described below.

The scene determination unit 311 receives the captured image SA and the imaging information SB from the camera 10, and determines a scene including the location and situation from the objects included in the captured image SA, based on the received imaging information SB. The scene determination unit 311 outputs the captured image SA, the imaging information SB, and the result of the scene determination to the image processing unit 312. The scene determination unit 311, for example, determines the scene by using a convolution neural network (CNN) having learned a large number of labeled images and imaging-time information. This CNN inputs the captured image SA and the imaging information SB and outputs the classification in the learned scene.

The image processing unit 312 subjects the captured image SA to the image quality enhancement processing based on the scene determination result output by the scene determination unit 311 and imaging information SB, to reduce an image quality defect. The result of the image quality enhancement processing is transmitted to the display apparatus 30 and displayed as an output image. The image processing unit 312 is an example of an image processing unit. The image quality enhancement processing includes noise reduction processing, fog and mist removal processing, super-resolution processing, and high dynamic range (HDR) processing, from which at least one piece of processing is selected. For example, if the gain is greater than a predetermined value, the image processing unit 312 performs noise reduction processing. If the contrast of the entire image is less than a predetermined value, the image processing unit 312 performs the fog and mist removal processing. For example, if the size of the moving object is less than a predetermined value, the image processing unit 312 performs the super-resolution processing. If the image includes a saturated region, the image processing unit 312 performs the HDR processing.

The selection of the image quality enhancement processing by the image processing unit 312 is not limited to the above-described method, and the relevant processing can be preset by the user.

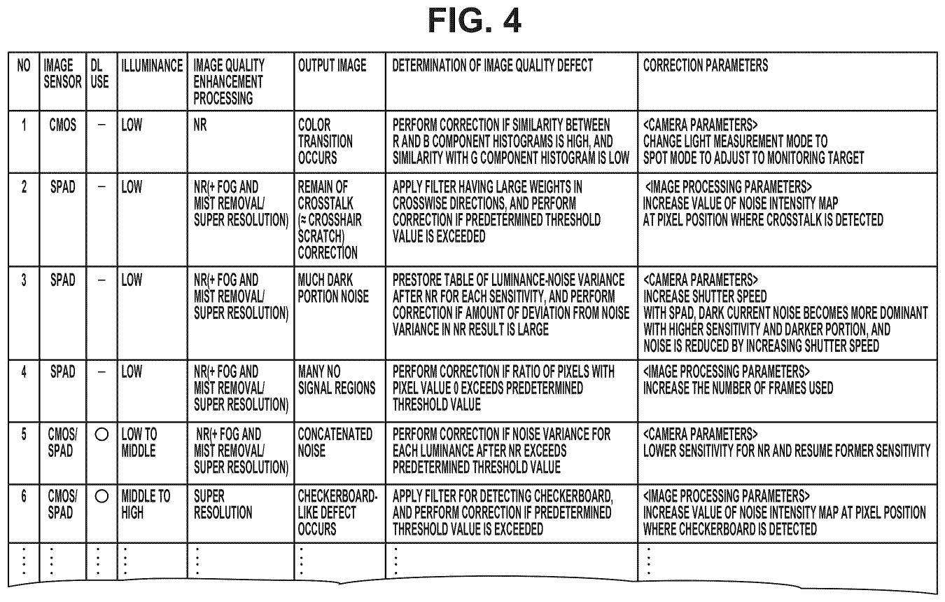

The analysis processing unit 313 analyzes the output image (the image having been subjected to the image quality enhancement processing by the image processing unit 312) to determine whether an image quality defect has occurred or the visibility can be further improved. The analysis processing unit 313 is an example of an analysis processing unit. The analysis processing performed by the analysis processing unit 313 depends on, for example, the imaging conditions, the type of the image sensor 202, the type of the image quality enhancement processing, the use of deep learning (DL) in the image quality enhancement processing, and the scene of the captured image. More specifically, as illustrated in the list in FIG. 4, the correction parameters are calculated based on the analysis processing and a correction parameter calculation method (described below) to be applied according to these conditions.

FIG. 4 illustrates examples of the analysis processing and the correction parameter calculation method. Referring to example No. 1 where the image sensor 202 is a CMOS sensor and noise reduction (NR) is used but DL is not used for the image quality enhancement processing, the analysis processing determines whether a color transition has occurred in the output image. In a case where the analysis processing determines that a color transition has occurred in the output image, the processing changes the white balance calculation mode of the camera 10 to the spot mode and calculates the correction parameters so that a white balance calculation region is adjusted to a color transition occurrence region. Examples Nos. 2 to 6 as well as example No. 1 will be described in detail below.

The parameter calculation unit 314 calculates the correction values of the camera parameters PA and the image processing parameters PB based on the analysis processing result by the analysis processing unit 313 to improve the visibility of the output image. The parameter calculation unit 314 transmits the calculated camera parameters PA to the parameter updating unit 302 of the camera 10 and transmits the calculated image processing parameters PB to the parameter updating unit 315 in the edge device 20. The image processing parameters PB include the offset, white balance, brightness, color, contrast, dynamic range, and defocusing of the captured image and other parameters for adjusting the intensity of the image quality enhancement processing. The parameter updating unit 315 updates the parameters for the image quality enhancement processing by the image processing unit 312 based on the image processing parameters PB calculated by the parameter calculation unit 314. The parameter calculation unit 314 and the parameter updating unit 315 are examples of an adjustment unit. The parameter calculation unit 314 is an example of a calculation unit, and the parameter updating unit 315 is an example of an updating unit.

### <Overall Processing of System>

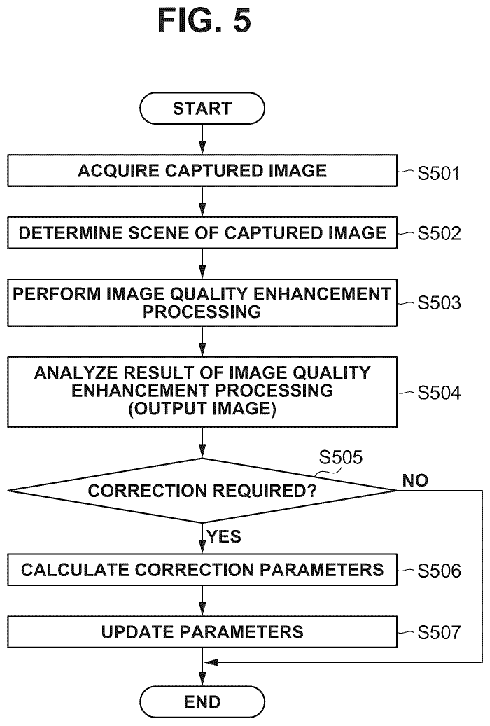

FIG. 5 is a flowchart illustrating an example of the overall processing by the imaging system according to the first exemplary embodiment. After the description of the overall processing, the analysis processing and the correction parameter calculation method will be described in detail below. In the following descriptions, the notation “S” means a processing step.

In step S501, the imaging unit 301 of the camera 10 captures an imaging target region to acquire the captured image SA, and transmits the captured image SA and the imaging information SB including the imaging-time setting values of the camera 10, to the edge device 20.

In step S502, the scene determination unit 311 of the edge device 20 determines the scene of the captured image SA acquired and transmitted by the camera 10 in step S501. The scene determination unit 311 receives the captured image SA and the imaging information SB transmitted from the camera 10, and based on the received imaging information SB, determines a scene including the location and situation from the objects included in the captured image SA.

In step S503, the image processing unit 312 of the edge device 20 subjects the captured image SA to the image quality enhancement processing based on the result of the scene determination in step S502 and the imaging information SB. Then, the image processing unit 312 outputs the image having been subjected to the image quality enhancement processing as an output image.

In step S504, the analysis processing unit 313 of the edge device 20 analyzes the output image resulting from the image quality enhancement processing in step S503.

In step S505, the analysis processing unit 313 determines, based on the result of the analysis processing in step S504, whether the camera parameters for the camera 10 and the image processing parameters for the image quality enhancement processing need to be corrected. The analysis processing unit 313 determines, based on the result of the analysis processing in step S504, whether an image quality defect has occurred in the output image or whether the visibility can be further improved. When the analysis processing unit 313 determines that an image quality defect has occurred or the visibility can be further improved, the analysis processing unit 313 determines that the camera parameters and the image processing parameters need to be corrected. In a case where the analysis processing unit 313 determines that the camera parameters and the image processing parameters need to be corrected (YES in step S505), the processing proceeds to step S506. In a case where the analysis processing unit 313 determines that the camera parameters and the image processing parameters do not need to be corrected (NO in step S505), the analysis processing unit 313 completes the processing illustrated in FIG. 5.

In step S506, the parameter calculation unit 314 of the edge device 20 calculates the correction parameters (the camera parameters PA and the image processing parameters PB) and transmits the correction parameters to the parameter updating unit 302 of the camera 10 and the parameter updating unit 315 of the edge device 20. The parameter calculation unit 314 calculates the correction values for the camera parameters PA and the image processing parameters PB based on the result of the analysis processing in step S504 to prevent an image quality defect and improve the visibility of the output image.

In step S507, the parameter updating unit 302 of the camera 10 receives the camera parameters PA from the edge device 20 and updates the setting values of the camera 10 based on the received camera parameters PA. The parameter updating unit 315 of the edge device 20 updates the intensity of the image quality enhancement processing based on the image processing parameters PB calculated by the parameter calculation unit 314.

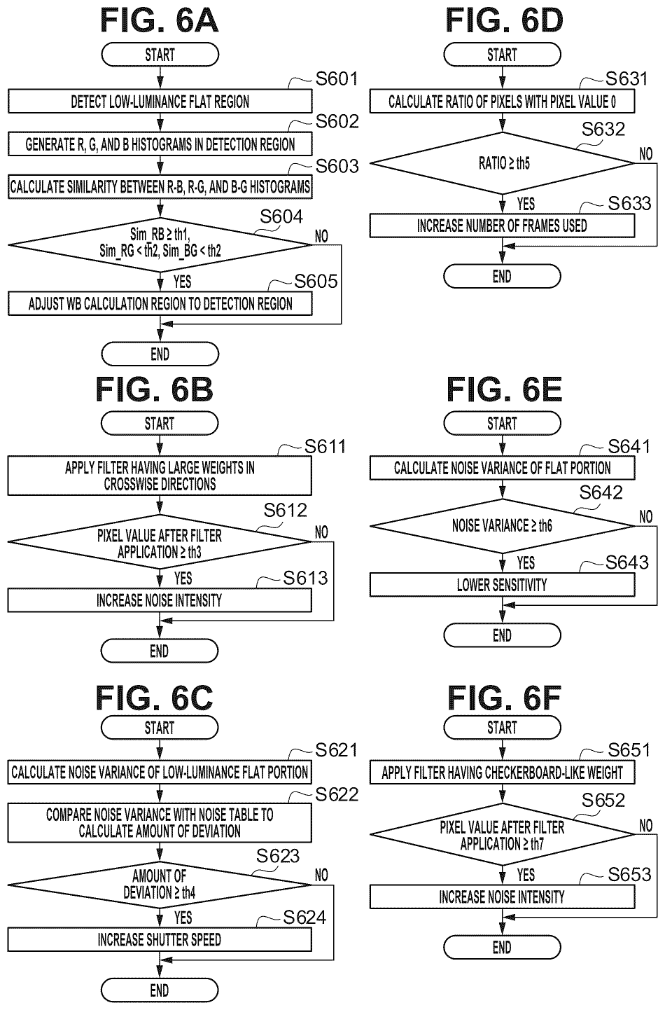

The processing in steps S504 to S506 in FIG. 5 for specific example Nos. 1 to 6 will be described below with reference to FIGS. 4 and 6A-6F.

Referring to the example No. 1 in FIG. 4 where the image sensor is a CMOS sensor and noise reduction (NR) is used, but deep learning (DL) is not used for the image quality enhancement processing. The analysis processing unit 313 determines whether a color transition has occurred in the image in the analysis processing. In a case where the analysis processing unit 313 determines that a color transition has occurred, the parameter calculation unit 314 calculates the correction parameters to change the camera parameters. An example of processing in this case will be described below with reference to the flowchart in FIG. 6A.

Referring to FIG. 6A, in step S601, the analysis processing unit 313 detects a low-luminance flat region as an analysis target region in the output image. In image capturing under a super-low-illuminance environment, for example, the night sky is detected as an analysis target region.

In step S602, the analysis processing unit 313 generates histograms of the R, G, and B components of the region detected as an analysis target in step S601.

In step S603, the analysis processing unit 313 calculates a similarity Sim_RB between the R and B histograms, a similarity Sim_RG between the R and G histograms, and a similarity Sim_BG between the B and G histograms based on the histograms of different components generated in step S602. For example, the similarity between vectors converted from histograms is used to calculate the similarity between histograms. The method for similarity calculation is not limited thereto, and other techniques for calculating the similarities and correlations between histograms are also applicable.

In step S604, the analysis processing unit 313 compares the similarities calculated in step S603 with threshold values th1 and th2 to determine whether all of conditions Sim_RB≥th1, Sim_RG<th2, and Sim_BG<th2 are satisfied. More specifically, the analysis processing unit 313 determines whether the similarity Sim_RB between the R and B histograms is greater than or equal to the threshold value th1 and whether both the similarity Sim_RG between the R and G histograms and the similarity Sim_BG between the B and G histograms are less than the threshold value th2. In a case where the analysis processing unit 313 determines that all of the conditions Sim_RB≥th1, Sim_RG<th2, and Sim_BG<th2 are satisfied (YES in step S604), the analysis processing unit 313 determines that a color transition occurred in the region detected as an analysis target. Then, the processing proceeds to step S605. In a case where the analysis processing unit 313 determines that at least one of the conditions Sim_RB≥th1, Sim_RG<th2, and Sim_BG<th2 is not satisfied (NO in step S604), the analysis processing unit 313 determines that a color transition has not occurred in the region detected as an analysis target. Then, the analysis processing unit 313 completes the analysis processing. In this way, in step S604, the analysis processing unit 313 determines, based on the similarities calculated in step S603, whether the parameters need to be corrected.

In step S605, the parameter calculation unit 314 calculates the correction parameters (the correction values of the camera parameters) to adjust the white balance calculation region to the region detected as an analysis target.

Referring to the example No. 2 in FIG. 4 where the image sensor is a SPAD sensor and NR is used, but DL is not used for the image enhancement processing. The analysis processing unit 313 determines whether a crosstalk has occurred in the image in the analysis processing. In a case where the analysis processing unit 313 determines that a crosstalk has occurred, the parameter calculation unit 314 calculates the correction parameters to change the image processing parameters. An example of processing in this case will be described below with reference to the flowchart in FIG. 6B.

Referring to FIG. 6B, in step S611, the analysis processing unit 313 applies a filter (with a filter size of, for example, 7×7) having a large weight in the crosswise directions to the output image.

In step S612, the analysis processing unit 313 compares the pixel value after the filter application with a threshold value th3 to determine whether the pixel value after the filter application is equal to or larger than the threshold value th3. In a case where the analysis processing unit 313 determines that the pixel value after the filter application is greater than or equal to the threshold value th3 (YES in step S612), the analysis processing unit 313 determines that a crosstalk occurred in the pixel. Then, the processing proceeds to step S613. In a case where the analysis processing unit 313 determines that the pixel value after the filter application is less than the threshold value th3 (NO in step S612), the analysis processing unit 313 completes the analysis processing. In this way, in step S612, the analysis processing unit 313 determines whether the parameters need to be corrected, based on the pixel value after the filter application.

In step S613, the parameter calculation unit 314 calculates the correction parameters (the correction values of the image processing parameters) for increasing the value of the noise intensity map of the pixel position where a crosstalk is detected to increase the intensity of the NR processing the larger the pixel value after the filter application.

Referring to the example No. 3 in FIG. 4 where the image sensor is a SPAD sensor and NR is used but DL is not used for the image enhancement processing. The analysis processing unit 313 determines whether the image includes much dark portion noise in the analysis processing. In a case where the analysis processing unit 313 determines that the image includes much dark portion noise, the parameter calculation unit 314 calculates the correction parameters to change the camera parameters. An example of processing in this case will be described below with reference to the flowchart in FIG. 6C.

Referring to FIG. 6C, in step S621, the analysis processing unit 313 calculates the noise variance of a low-luminance flat portion in the output image.

In step S622, the analysis processing unit 313 compares a noise table with the noise variance calculated in step S621 to calculate the amount of deviation. This noise table is prepared in advance and indicates the pre-calculated approximate amount of noise variance after NR according to the luminance for each sensitivity.

In step S623, the analysis processing unit 313 compares the amount of deviation calculated in step S622 with a threshold value th4 to determine whether the amount of deviation is greater than or equal to the threshold value th4. In a case where the analysis processing unit 313 determines that the amount of deviation calculated in step S622 is greater than or equal to the threshold value th4 (YES in step S623), the analysis processing unit 313 determines that the image includes much low-luminance portion noise. Then, the processing proceeds to step S624. In a case where the analysis processing unit 313 determines that the amount of deviation calculated in step S622 is smaller than the threshold value th4 (NO in step S623), the analysis processing unit 313 completes the analysis processing. In this way, in step S623, the analysis processing unit 313 determines, based on the amount of deviation calculated in step S622, whether the parameters need to be corrected.

In step S624, the parameter calculation unit 314 calculates the correction parameters (the correction values of the camera parameters) for increasing the shutter speed of the camera 10. With a SPAD sensor, dark current noise becomes more dominant with higher sensitivity and lower luminance and can be reduced by increasing the shutter speed.

Referring to the example No. 4 in FIG. 4 where the image sensor is a SPAD sensor and NR is used but DL is not used for the image enhancement processing. The analysis processing unit 313 determines whether the image includes many no-signal regions (regions with the pixel value 0) in the analysis processing. In a case where the analysis processing unit 313 determines that many regions are occupied by pixels with the pixel value 0, the parameter calculation unit 314 calculates the correction parameters to change the image processing parameters. An example of processing in this case will be described in detail below with reference to the flowchart in FIG. 6D.

Referring to FIG. 6D, in step S631, the analysis processing unit 313 counts the number of pixels with the pixel value 0 in the output image, and calculates the ratio of pixels with the pixel value 0 to the entire image.

In step S632, the analysis processing unit 313 compares the ratio of pixels with the pixel value 0 calculated in step S631 with a threshold value th5 to determine whether the ratio of pixels with the pixel value 0 is greater than or equal to the threshold value th5. In a case where the analysis processing unit 313 determines that the ratio of pixels with the pixel value 0 calculated in step S631 is greater than or equal to the threshold value th5 (YES in step S632), the processing proceeds to step S633. In a case where the analysis processing unit 313 determines that the ratio of pixels with the pixel value 0 calculated in step S631 is less than the threshold value th5 (NO in step S632), the analysis processing unit 313 completes the analysis processing. In this way, in step S632, the analysis processing unit 313 determines, based on the ratio of pixels with the pixel value 0 calculated in step S631, whether the parameters need to be corrected.

In step S633, the parameter calculation unit 314 calculates the correction parameters (the correction values of the image processing parameters) for increasing the number of frames to be used for the image quality enhancement processing.

Referring to the example No. 5 in FIG. 4 where both NR and DL are used for the image quality enhancement processing. The analysis processing unit 313 determines whether a streak-like artifact with concatenated noise has occurred in the image in the analysis processing. In a case where a deep neural network is utilized, this artifact often appears as a result of performing the NR processing on unlearned noise. In a case where the analysis processing unit 313 determines that an artifact has occurred, the parameter calculation unit 314 calculates the correction parameters to change the camera parameters. An example of processing in this case will be described below with reference to the flowchart in FIG. 6E.

Referring to FIG. 6E, in step S641, the analysis processing unit 313 calculates the noise variance of flat portions in the output image.

In step S642, the analysis processing unit 313 compares the noise variance calculated in step S641 with a threshold value th6 to determine whether the noise variance is greater than or equal to the threshold value th6. In a case where the analysis processing unit 313 determines that the noise variance calculated in step S641 is greater than or equal to the threshold value th6 (YES in step S642), the analysis processing unit 313 determines that an artifact has occurred. Then, the processing proceeds to step S643. In a case where the analysis processing unit 313 determines that the noise variance calculated in step S641 is less than the threshold value th6 (NO in step S642), the analysis processing unit 313 completes the analysis processing. In this way, in step S642, the analysis processing unit 313 determines, based on the noise variance calculated in step S641, whether the parameters need to be corrected.

In step S643, the parameter calculation unit 314 performs NR with the sensitivity of the camera 10 lowered (for example, by 3 to 5 steps) and then calculates the correction parameters (the correction values of the camera parameters) for resuming the former sensitivity.

Referring to the example No. 6 in FIG. 4 where both NR and DL are used for the image quality enhancement processing. The analysis processing unit 313 determines whether a checkerboard-like artifact has occurred in the image in the analysis processing. In a case where a convolution neural network is utilized, this artifact often appears if an inverse convolution layer is used or specific learning data is insufficient. In a case where the analysis processing unit 313 determines that an artifact has occurred, the parameter calculation unit 314 calculates the correction parameters to change the image processing parameters. An example of processing in this case will be described below with reference to the flowchart in FIG. 6F.

Referring to FIG. 6F, in step S651, the analysis processing unit 313 applies a filter (with a filter size of, for example, 7×7) with two different (large and small) checkerboard-like weights alternately set to the output image.

In step S652, the analysis processing unit 313 compares the pixel value after the filter application with a threshold value th7 to determines whether the pixel value after the filter application is greater than or equal to the threshold value th7. In a case where the analysis processing unit 313 determines that the pixel value after the filter application is greater than or equal to the threshold value th7 (YES in step S652), the analysis processing unit 313 determines that a checkerboard-like artifact has occurred. Then, the processing proceeds to step S653. In a case where the analysis processing unit 313 determines that the pixel value after the filter application is less than the threshold value th7 (NO in step S652), the analysis processing unit 313 completes the analysis processing. In this way, in step S652, the analysis processing unit 313 determines, based on the pixel value after the filter application, whether the parameters need to be corrected.

In step S653, the parameter calculation unit 314 calculates the correction parameters (the correction values of the image processing parameters) for increasing the value of the noise intensity map of the pixel position where an artifact is detected to increase the intensity of the NR processing the larger the pixel value after the filter application.

The first exemplary embodiment has been described above directed to a method for analyzing the result of the image quality enhancement processing and updating the parameters of the camera 10 for image capturing and the parameters of the edge device 20 for performing the image quality enhancement processing to improve the visibility. Cameras such as monitoring cameras are subjected to the adjustment of various parameters to prevent an image quality defect from occurring and draw the performance to the maximum. However, it is difficult to cover all of imaging conditions by using initial parameters, and an image quality defect is likely to occur under a bad environment such as very low illuminance and dense fog. Conventionally, when performing image capturing under such an environment and if the visibility is low, parameter adjustment has been manually performed. Adjusting the parameters on a fully automatic basis as in the above-described first exemplary embodiment enables improving the visibility of a captured image while reducing user effort.

While the above-described first exemplary embodiment has been described above using a RAW image with the Bayer array as a captured image, other color filter arrays and a developed Red, Green, and Blue (RGB) image are also applicable.

The present exemplary embodiment has been described above on the premise that the camera parameters and the image processing parameters are updated at the timing when, after the image quality enhancement processing, the result of the relevant processing has been analyzed and the correction values have been calculated. However, an image quality defect can occur again after the correction. In such a case, there can be provided a mechanism for detecting a certain brightness or a color variation in the captured image or output image, and the analysis processing can be performed at the detection timing, and the camera parameters and the image processing parameters can be adjusted. When specified by the user or when a preset time period has elapsed, the analysis processing can be performed to adjust the camera parameters and the image processing parameters.

In the above-described first exemplary embodiment, if an image quality defect is determined to have occurred as a result of analyzing the result of the image quality enhancement processing, processing for calculating the correction parameters and updating the camera and edge device parameters is performed on a fully automatic basis.

A second exemplary embodiment will be described below directed to a method for favorably displaying a specific region preselected or preset from the captured image by the user to implement flexible correction. The following description will be directed to differences between the present exemplary embodiment and the first exemplary embodiment, and description(s) will be omitted for contents common to the first exemplary embodiment.

### <System Configuration>

FIG. 1B illustrates an example of an imaging system configuration according to a second exemplary embodiment. In the imaging system illustrated in FIG. 1B, the camera 10 for image capturing, an edge device 40 for subjecting a captured image to the image quality enhancement processing, an edge device 50 for analyzing the result of the image quality enhancement processing, and a display apparatus 30 for displaying a screen of the image having been subjected to the image quality enhancement processing.

The hardware configurations of the edge devices 40 and 50 according to the second exemplary embodiment are similar to the hardware configuration of the edge device 20 according to the first exemplary embodiment. The functional configurations of the edge devices 40 and 50 according to the second exemplary embodiment are different from the functional configuration of the edge device 20 according to the first exemplary embodiment.

The edge device 40 according to the present exemplary embodiment acquires RAW image data (Bayer array) output from the camera 10 as an input image to be subjected to the image quality enhancement processing. Then, the edge device 40 performs the image quality enhancement processing on the input image to be subjected to the image quality enhancement processing, and transmits the output image (the image having been subjected to the image quality enhancement processing) to the display apparatus 30 and the edge device 50. The edge device 50 according to the present exemplary embodiment receives the output image from the edge device 40, analyzes the output image, calculates the correction parameters for the camera 10 or the edge device 20 as required based on the result of analyzing the output image, transmits the correction parameters, and updates the image quality enhancement processing.

### <Functional Configuration of System>

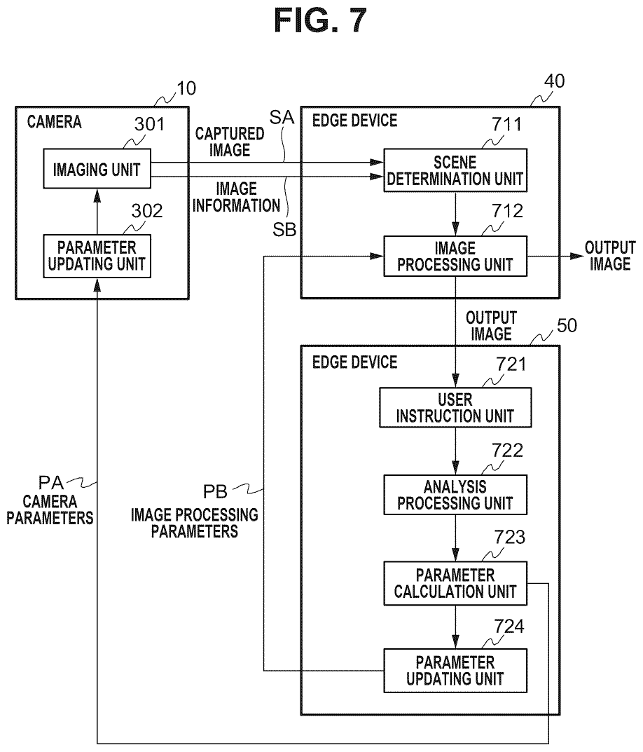

FIG. 7 is a block diagram illustrating an example of a functional configuration of the imaging system according to the second exemplary embodiment. Referring to FIG. 7, components identical to those in FIG. 3 are assigned the same reference numerals, and duplicated descriptions thereof will be omitted. The edge device 40 includes a scene determination unit 711 and an image processing unit 712. The edge device 50 includes a user instruction unit 721, an analysis processing unit 722, a parameter calculation unit 723, and a parameter updating unit 724. The camera 10 according to the second exemplary embodiment is similar to the camera 10 according to the first exemplary embodiment. The camera 10 is an example of an imaging unit, the edge device 40 is an example of a first processing apparatus, and the edge device 50 is an example of a second processing apparatus. Each function unit illustrated in FIG. 7 is, for example, implemented when the CPU 203 of the camera 10 and the CPUs of the edge devices 40 and 50 execute computer programs for implementing each function. All or a part of the function unit illustrated in FIG. 7 can be implemented by hardware.

The edge device 40 will be described below.

The scene determination unit 711, like the scene determination unit 311 according to the first exemplary embodiment, receives a captured image SA and imaging information SB from the camera 10, and determines, based on the received imaging information SB, a scene including the location and situation from the objects included in the captured image SA. The scene determination unit 711 outputs the captured image SA, the imaging information SB, and the result of the scene determination to the image processing unit 712.

The image processing unit 712, like the image processing unit 312 according to the first exemplary embodiment, subjects the captured image SA to the image quality enhancement processing for reducing an image quality defect, based on the result of the scene determination output by the scene determination unit 711 and the imaging information SB. The result of the image quality enhancement processing is transmitted, for example, to the display apparatus 30 to be displayed thereon. The image processing unit 712 transmits the output image (the image having been subjected to the image quality enhancement processing) to the edge device 50.

The edge device 50 will be described below.

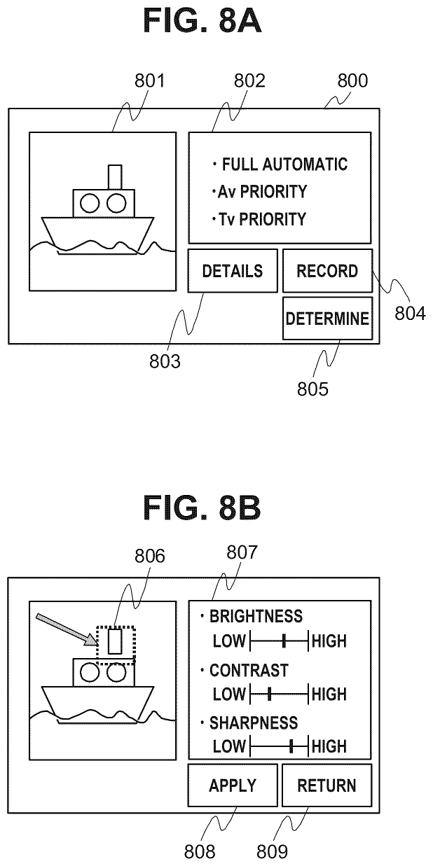

The user instruction unit 721 receives a user instruction issued by the user, via graphical user interfaces (GUIs) as illustrated in FIGS. 8A and 8B. The user can subject the output image to the selection of the correction mode, the setting of a specific region to be subjected to visibility improvement, and the adjustment of correction intensity of brightness, contrast, and sharpness, via GUI screens.

A GUI screen 800 illustrated in FIG. 8A displays an output image 801 having been subjected to the image quality enhancement processing, and a priority mode selection window 802 at the time of the image quality enhancement processing. The GUI screen 800 displays a Details button 803 for adjusting the correction intensities, a Record button 804 for recording settings, and a Determine button 805 for reflecting the settings. Examples of priority modes selectable from the priority mode selection window 802 include the fully automatic mode for automatically performing the image quality enhancement processing like the processing according to the first exemplary embodiment, the Av priority mode for giving priority to the aperture of the camera 10, and the Tv priority mode for giving priority to the shutter speed.

The user can set a specific region 806 with any desired size to the output image 801 displayed in the GUI screen 800 as illustrated in the example in FIG. 8B, making it possible to change the correction intensities in the region 806. When changing the correction intensity, selecting the Details button 803 illustrated in FIG. 8A displays, for example, an intensity adjustment window 807 illustrated in FIG. 8B, enabling the user to adjust the intensities of the brightness, contrast, and sharpness using respective slide bars. Selecting the Apply button 808 reflects the adjustment of the correction intensities using the intensity adjustment window 807. Selecting the Return button 809 causes the screen to return to the GUI screen 800 illustrated in FIG. 8A. Selecting the Record button 804 illustrated in FIG. 8A enables recording the correction mode and intensity adjustment settings by the user in the mass-storage storage device 214 in the edge device 50, enabling the user to use the settings from the next time on.

The analysis processing unit 722, like the analysis processing unit 313 according to the first exemplary embodiment, analyzes the output image (the image having been subjected to the image quality enhancement processing) to determine whether an image quality defect has occurred or whether the visibility can be further improved. The analysis processing unit 722 performs the analysis processing for the specific region set via the user instruction unit 721.

The parameter calculation unit 723 calculates the correction values of the camera parameters PA and the image processing parameters PB based on the intensity adjustment set via the user instruction unit 721 and the result of the analysis processing by the analysis processing unit 722, to improve the visibility of the output image. The parameter calculation unit 723, like the parameter calculation unit 314 according to the first exemplary embodiment, calculates the correction values of the camera parameters PA and the image processing parameters PB, based on the result of the analysis processing by the analysis processing unit 722. Then, the parameter calculation unit 723 multiplies the calculated image processing parameters PB by the intensity adjustment value set by the user via the user instruction unit 721 to adjust the intensities of the correction parameters. The value of each intensity adjustment is based on 1. If the value is less than 1, the correction intensity decreases. If the value is greater than 1, the correction intensity increases. The parameter calculation unit 723 transmits the calculated camera parameters PA to the parameter updating unit 302 of the camera 10, and transmits the calculated image processing parameters PB to the parameter updating unit 724 in the edge device 50.

The parameter updating unit 724 updates, based on the image processing parameters PB calculated by the parameter calculation unit 723, the parameters for the image quality enhancement processing by the image processing unit 712 of the edge device 40. In the example illustrated in FIG. 7, the parameter updating unit 724 is provided in the edge device 50. However, the parameter updating unit 724 can be provided in the edge device 40 to update the parameters for the image quality enhancement processing.

### <Overall Processing of System>

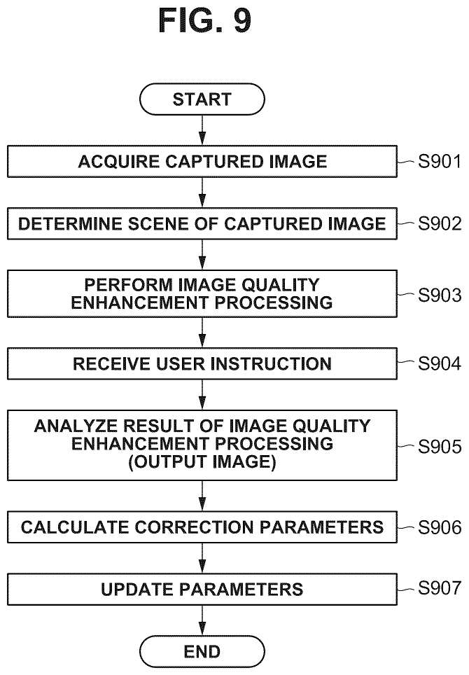

Various processing performed by the imaging system according to the second exemplary embodiment will be described below with reference to FIG. 9. FIG. 9 is a flowchart illustrating an example of processing by the imaging system according to the second exemplary embodiment.

In step S901, the imaging unit 301 of the camera 10 captures the imaging target region to acquire the captured image SA, and transmits the captured image SA and the imaging information SB including the imaging-time setting values of the camera 10 to the edge device 40.

In step S902, the scene determination unit 711 of the edge device 40 determines the scene of the captured image SA acquired and transmitted by the camera 10 in step S901. The scene determination unit 711 receives the captured image SA and the imaging information SB transmitted from the camera 10, and determines, based on the received imaging information SB, a scene including the location and situation from the objects included in the captured image SA.

In step S903, the image processing unit 712 of the edge device 40 subjects the captured image SA to the image quality enhancement processing based on the result of the scene determination in step S902 and the imaging information SB. Then, the image processing unit 712 transmits the image having been subjected to the image quality enhancement processing to the display apparatus 30 and the edge device 50 as an output image.

In step S904, the user instruction unit 721 of the edge device 50 receives the specific region of the analysis target and the intensity adjustment for the image quality enhancement processing specified by the user via the GUI screen 800.

In step S905, the analysis processing unit 722 of the edge device 50 analyzes the output image resulting from the image quality enhancement processing in step S903. In the analysis processing in step S905, the analysis processing unit 722 performs the analysis processing on a specific region in the output image specified as an analysis target by the user.

In step S906, the parameter calculation unit 723 of the edge device 50 calculates the correction parameters (the camera parameters PA and the image processing parameters PB) based on the intensity adjustment specified by the user and the result of the analysis processing in step S905. Then, the parameter calculation unit 723 transmits the calculated correction parameters to the parameter updating unit 302 of the camera 10 and the parameter updating unit 724 of the edge device 50.

In step S907, the parameter updating unit 302 of the camera 10 receives the camera parameters PA from the edge device 50 and updates the setting values of the camera 10 based on the received camera parameters PA. The parameter updating unit 724 of the edge device 50 controls the parameters of the image processing unit 712 of the edge device 40 based on the image processing parameters PB calculated by the parameter calculation unit 723 to update the intensity of the image quality enhancement processing. The second exemplary embodiment has been described above directed to a method for displaying a specific region selected or set from the captured image by the user. The above-described second exemplary embodiment enables flexibly improving the visibility of the captured image via a user instruction, and performing the image quality enhancement processing and the analysis processing with separate edge devices to enable distributing the processing load.

According to the above-described first and second exemplary embodiments, if an image quality defect is determined to have occurred as a result of analyzing the result of the image quality enhancement processing on the captured image, the correction parameters are calculated and the camera and edge device parameters are updated on a fully automatic basis or via a user instruction.

A third exemplary embodiment will be described below directed to a method for using a radar (millimeter wave/microwave). More specifically, the method detects an object that cannot be detected by the camera 10 and, controls the operation of the pan head of the camera to display the object with a suitable size at the center position of the captured image based on positional information of the target object. The following description will be directed to differences between the present exemplary embodiment and the first and second exemplary embodiments, and description(s) will be omitted for contents regarding the basic configurations of the imaging system common to the first and the second exemplary embodiments.

### <System Configuration>

FIG. 1C illustrates an example configuration of an imaging system according to the third exemplary embodiment. In the imaging system illustrated in FIG. 1C, a pan head 70 for controlling the orientation and viewing angle of the camera 10, and a radar 80 for detecting an object are additionally connected with the imaging system in FIG. 1B.

### <Hardware Configuration of System>

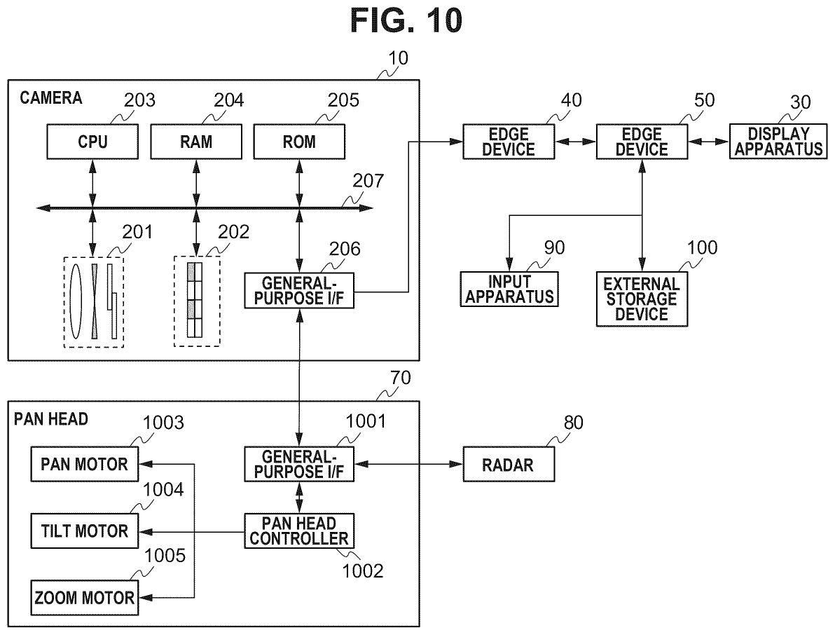

FIG. 10 is a block diagram illustrating an example of a hardware configuration of the imaging system according to the third exemplary embodiment. Referring to FIG. 10, components identical to those in FIG. 2 are assigned the same reference numerals, and duplicated descriptions thereof will be omitted. The pan head 70 includes a general-purpose I/F 1001, a pan head controller 1002, a pan motor 1003, a tilt motor 1004, and a zoom motor 1005. The pan head 70 is connected with the camera 10 and the radar 80 via the general-purpose I/F 1001. The pan head controller 1002 controls the pan motor 1003 for moving the camera 10 in the pan direction, the tilt motor 1004 for moving the camera 10 in the tilt direction, and the zoom motor 1005 for zooming in or out. The radar 80 detects an object by using a millimeter wave or microwave and transmits object positional information of the detected object to the pan head 70. The pan head 70 is an example of a control unit, and the radar 80 is an example of an object detection unit.

### <Functional Configuration of System>

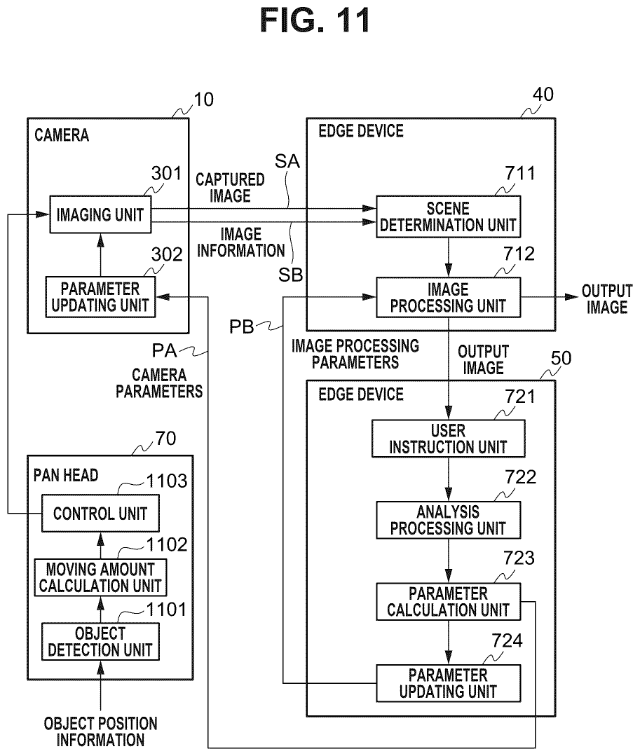

FIG. 11 is a block diagram illustrating an example of the functional configuration of the imaging system according to the third exemplary embodiment. Referring to FIG. 11, components identical to those in FIGS. 3 and 7 are assigned the same reference numerals, and duplicated descriptions thereof will be omitted. The pan head 70 includes an object detection unit 1101, a moving amount calculation unit 1102, and a control unit 1103. The camera 10 according to the third exemplary embodiment is similar to the camera 10 according to the first and the second exemplary embodiments, and the edge devices 40 and 50 are similar to the edge devices 40 and 50 according to the second exemplary embodiment.

The object detection unit 1101 receives object positional information from the radar 80 and detects the position and orientation of the object based on the received object positional information. The moving amount calculation unit 1102 calculates, based on the position and orientation of the object detected by the object detection unit 1101, the moving amount for turning the camera 10 so that the object is displayed with a suitable size at the center position of the captured image. The control unit 1103 controls, based on the moving amount calculated by the moving amount calculation unit 1102, the drive of the pan head 70 and the camera 10 and controls the orientation and viewing angle of the camera 10.

### <Overall Processing of System>

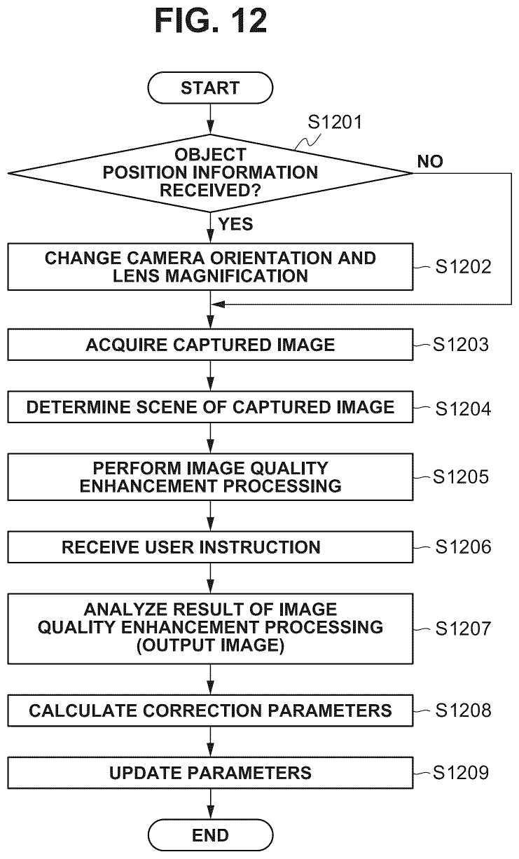

FIG. 12 is a flowchart illustrating an example of processing of the imaging system according to the third exemplary embodiment.

In step S1201, the object detection unit 1101 of the pan head 70 determines whether the object positional information is received from the radar 80. In a case where the object detection unit 1101 determines that the object positional information is received from the radar 80 (YES in step S1201), the processing proceeds to step S1202. In a case where the object detection unit 1101 determines that the object positional information is not received (NO in step S1201), the processing proceeds to step S1203.

In step S1202, the pan head 70 changes the orientation of the camera 10 and the lens magnification based on the object positional information received from the radar 80. More specifically, the object detection unit 1101 detects the position and orientation of the object based on the object positional information received from the radar 80, and the moving amount calculation unit 1102 calculates the moving amount for turning the camera 10 to the relevant position and orientation. Then, the control unit 1103 controls the drive of the pan head 70 and the camera 10 based on the calculated moving amount, and controls the orientation of the camera 10 and the lens magnification so that the object is displayed with a suitable size at the center position of the captured image.

In step S1203, the imaging unit 301 of the camera 10 captures the imaging target region to acquire the captured image SA, and transmits the captured image SA and the imaging information SB including the imaging-time setting values of the camera 10 to the edge device 40.

In step S1204, the scene determination unit 711 of the edge device 40 determines the scene of the captured image SA acquired and transmitted by the camera 10 in step S1203. The scene determination unit 711 receives the captured image SA and the imaging information SB transmitted from the camera 10, and determines, based on the received imaging information SB, a scene including the location and situation from the objects included in the captured image SA.

In step S1205, the image processing unit 712 of the edge device 40 subjects the captured image SA to the image quality enhancement processing based on the result of the scene determination in step S1204 and the imaging information SB. Then, the image processing unit 712 transmits the image having been subjected to the image quality enhancement processing to the display apparatus 30 and the edge device 50 as an output image.

In step S1206, the user instruction unit 721 of the edge device 50 receives the specific region of the analysis target and the intensity adjustment for the image quality enhancement processing specified by the user via the GUI screen 800.

In step S1207, the analysis processing unit 722 of the edge device 50 analyzes the output image resulting from the image quality enhancement processing in step S1205. In the analysis processing in step S1207, the analysis processing unit 722 performs the analysis processing on a specific region in the output image specified as an analysis target by the user.

In step S1208, the parameter calculation unit 723 of the edge device 50 calculates the correction parameters (the camera parameters PA and the image processing parameters PB) based on the intensity adjustment specified by the user and the result of the analysis processing in step S1207. Then, the parameter calculation unit 723 transmits the calculated correction parameters to the parameter updating unit 302 of the camera 10 and the parameter updating unit 724 of the edge device 50.

In step S1209, the parameter updating unit 302 of the camera 10 receives the camera parameters PA from the edge device 50 and updates the setting values of the camera 10 based on the received camera parameters PA. The parameter updating unit 724 of the edge device 50 controls the parameters of the image processing unit 712 of the edge device 40 based on the image processing parameters PB calculated by the parameter calculation unit 723 to update the intensity of the image quality enhancement processing.

The third exemplary embodiment has been described above directed to a method for controlling the operation of the pan head of the camera 10 so that the moving object is displayed with a suitable size at the center position of the captured image through the combination of the camera 10, the pan head 70, and the radar 80. Using an external apparatus such as a radar, enables identifying positional information of the monitoring target and improving the visibility of the moving object that can be a monitoring target in the captured image.

The second and the third exemplary embodiments have been described above directed to an example where the image quality enhancement processing and the analysis processing are performed by separate edge devices. However, like the first exemplary embodiment, the image quality enhancement processing and the analysis processing can be performed by one edge device.

### (Other Exemplary Embodiments of Present Disclosure)

The present disclosure can also be achieved when a program for implementing at least one of the functions according to the above-described exemplary embodiments is supplied to a system or apparatus via a network or storage medium, and at least one processor in the computer of the system or apparatus reads and executes the program. The present disclosure can also be achieved by a circuit such as an application specific integrated circuit (ASIC) for implementing at least one function.

The above-described exemplary embodiments of the present disclosure are to be considered as illustrative in embodying the present disclosure, and are not to be interpreted as restrictive on the technical scope of the present disclosure. The present disclosure may be embodied in diverse forms without departing from the technical concepts or essential characteristics thereof.

The present disclosure enables improving image visibility while reducing user burden.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2023-215572, filed Dec. 21, 2023, which is hereby incorporated by reference herein in its entirety.

What is claimed is:

1. An image processing apparatus comprising:
a memory storing a program; and
a processor, that when executing the program, executes processing to:
subject a captured image, acquired by an imaging unit, to image quality enhancement processing to reduce an image quality defect; and
adjust, based on a result of analyzing the captured image subjected to the image quality enhancement processing, at least one of parameters related to the imaging unit or parameters related to the image quality enhancement processing.

2. The image processing apparatus according to claim 1, wherein the processing is further executed to:
calculate correction values of the parameters based on the result of analyzing the captured image subjected to the image quality enhancement processing; and
update the parameters based on the calculated correction values.

3. The image processing apparatus according to claim 1, wherein analyzing the captured image subjected to the image quality enhancement processing depends on at least one of a type of an image sensor of the imaging unit, a type of the image quality enhancement processing, a use of deep learning in the image quality enhancement processing, or a scene of the captured image.

4. The image processing apparatus according to claim 1,
wherein analyzing the captured image subject to the image quality enhancement processing includes determining whether an image quality defect has occurred in the captured image subjected to the image quality enhancement processing, and
wherein, if an image quality defect has occurred in the captured image subjected to the image quality enhancement processing, the parameters are adjusted.

5. The image processing apparatus according to claim 1, wherein the processing is further executed to adjust the parameters based on a result of analyzing a specific region set as an analysis target of the captured image subjected to the image quality enhancement processing.

6. The image processing apparatus according to claim 1, wherein at least one of a method for calculating the parameters for adjusting the parameters or an intensity of the adjustment is settable by a user.

7. The image processing apparatus according to claim 1, wherein the image quality enhancement processing includes at least one of noise reduction processing, fog and mist removal processing, or super-resolution processing.

8. The image processing apparatus according to claim 1, wherein the parameters related to the imaging unit include at least one of an aperture value, shutter speed, sensitivity, focal distance, or white balance calculation mode.

9. The image processing apparatus according to claim 1, wherein the parameters related to the image quality enhancement processing include at least one of correction parameters related to a brightness, color, contrast, dynamic range, or blur of the captured image.

10. An imaging system comprising:
an imaging unit configured to acquire a captured image; and
an image processing apparatus, the image processing apparatus comprising: a memory storing a program; and
a processor, that when executing the program, executes processing to:
subject the captured image to image quality enhancement processing to reduce an image quality defect; and
adjust, based on a result of analyzing the captured image subjected to the image quality enhancement processing, at least one of parameters related to the imaging unit or parameters related to the image quality enhancement processing.

11. An imaging system comprising:
a first processing apparatus configured to subject a captured image, acquired by an imaging unit, to image quality enhancement processing for reducing an image quality defect; and
a second processing apparatus in communication with the first processing apparatus and configured to, based on a result of analyzing the captured image subjected to the image quality enhancement processing, adjust at least one of parameters related to the imaging unit or parameters related to the image quality enhancement processing.

12. The imaging system according to claim 11, further comprising a third apparatus configured to, based on positional information of a detected object, control at least one of an orientation or a viewing angle of the imaging unit.

13. An image processing method comprising:
subjecting a captured image, acquired by an imaging unit, to image quality enhancement processing to reduce an image quality defect; and
adjusting, based on a result of analyzing the captured image subjected to the image quality enhancement processing, at least one of parameters related to the imaging unit or parameters related to the image quality enhancement processing.

14. A non-transitory computer-readable storage medium storing a program that, when executed by a computer of image processing apparatus, causes the computer to perform a method, the method comprising:
subjecting a captured image, acquired by an imaging unit, to image quality enhancement processing to reduce an image quality defect; and
adjusting, based on a result of analyzing the captured image having been subjected to the image quality enhancement processing, at least one of parameters related to the imaging unit or parameters related to the image quality enhancement processing.
